(19) United States
(12) Patent Application Publication
(10) Pub. No.: US 2005/0161006 A1
(43) Pub. Date: Jul. 28, 2005

(54) Livestock sorter by weight

(76) Inventors: Brian D. Reimer, Beiseker (CA); Leon King, Airdrie (CA)

Correspondence Address: ADE & COMPANY, 1700-360 MAIN STREET, WINNIPEG, MB, R3C3Z3, CA

(21) Appl. No.: 10/761,791

(22) Filed: Jan. 22, 2004

(51) Int. Cl. A01K 29/00

(52) U.S. Cl. 119/842

(57) ABSTRACT

A livestock sorter includes a weighing scale within a confining cage for obtaining a weight of the animal to be sorted depending on its reaching a predetermined market weight. Front and rear gates are each formed by two gate panels which are pivotal about a vertical axis at an outer edge of the gate panel. The gate panels are opened and closed by symmetrical levers and links connected from the gate panel to an actuating member slidable in a slide track along the midline of the container in response to an actuating force from a drive member. The actuating member, the links and the levers are arranged overcenter against an end stop of the guide track such that, with the gate panels in the closed position, force from the animal on the gate panels tending to open the gate panels provides no force through the links and the actuating member to the drive member.

This invention relates to a sorter for livestock, primarily but not necessarily hogs, by which the animals can be weighed and directed to separate pens depending upon whether they are above or below a predetermined weight. This can be used for selecting animals at market weight and directing them to a holding pen if above the required weight but it can also be used for dividing animals into different feed pens depending upon their weight to manage feeding.

### BACKGROUND OF THE INVENTION

Hog sorters have been known for a number of years which are used to separate hogs of market weight from those which remain underweight. One commonly known product is manufactured by the present applicants and comprises a confining cage or container with a front gate and a rear gate and a weigh pan at the bottom of the container so that the contained animal stands on the weigh pan for the weight to be measured. During the weighing action, the front and rear gates are closed. In front of the front gate is a movable sorting panel which can be moved to one side or the other depending upon the measured weight.

Each of the gates is formed from two gate panels with the gate panels pivotal relative to the container about a vertical axis at an outer edge of the gate panel so that the gate panels come together across the container to form the gate closing the container and preventing the animal from movement within the container.

Sorters of this type are generally operated by air pressure which drives air cylinders for actuating movement of the gates and the separation panel. Air cylinders generally operate at the pressure of the order of 100 PSI so that pressure on the cylinder can cause the cylinder to be moved unintentionally.

One problem which has arisen in sorters of this type is that the animal can press against the front or rear gate and apply significant force which can overcome the pressure in the cylinder and press open the gates. Once the hogs have realized that the gates can be opened, they are encouraged to apply pressure against the gates in an attempt to escape the confinement.

It remains therefore a problem to be solved that an operating arrangement should be provided which utilizes a cylinder to actuate the movement but which prevents the animal from forcing open the gates in an attempt to escape. Once the animal realizes that the gates are impregnable, there is a reduction in any encouragement or incentive to attempt to escape thus reducing the problem. It will be appreciated that attempts to escape even if not successful can lead to wear or damage on the parts of the sorter.

### SUMMARY OF THE INVENTION

It is one object of the invention to provide an improved livestock sorter where the animal is contained in the container and prevented from pushing open the gates at the front and rear by the construction of the opening linkage.

According to one aspect of the invention there is provided a livestock sorter comprising:
side walls defining a confining container for an animal to be sorted;
a base plate on which the animal stands when confined in the container;
a weighing scale supporting the base plate for obtaining a weight of the animal when confined as it stands on the base plate;
a front gate at the front of the container moveable from an open position allowing passage of the animal to a closed position for preventing forward movement of the animal while it is being weighed;
a rear gate at the rear of the container moveable from an open position allowing passage of the animal to a closed position for preventing rearward movement of the animal while it is being weighed;
the front gate comprising a left side vertical gate panel and a right side vertical gate panel;
each of the gate panels being pivotal about a vertical axis at an outer edge of the gate panel from the closed position extending across the container generally at right angles to a mid line toward the mid line though an angle of the order of 90 degrees to an open position generally parallel to the mid line;
and front and a rear drive construction for effecting movement of the front and rear gates respectively between the open and closed positions, each drive construction comprising:
a left lever connected to the left gate panel and arranged such that pivotal movement of the left lever about the axis of the left gate panel causes said pivotal movement of the left gate panel;
a right lever connected to the right gate panel and arranged such that pivotal movement of the right lever about the axis of the right gate panel causes said pivotal movement of the right gate panel;
an actuating member movable along the midline of the container in response to an actuating force from a drive member;
a left link pivotally connected to the actuating member and to the left lever;
a right link pivotally connected to the actuating member and to the right lever;
the actuating member, the links and the levers being arranged such that movement of the actuating member to a first position along the mid line causes the actuating member to provide a force on the levers through the links to pivot the gate panels to the open position and such that movement of the actuating member to a second position along the mid line causes the actuating member to provide a force on the levers through the links to pivot the gate panels to the closed position;
the actuating member, the links and the levers being arranged such that, in the second position with the gate panels in the closed position, force from the animal on the gate panels tending to open the gate panels provides substantially no force through the links and the actuating member to the drive member.

Preferably the links and the actuation member are arranged in an overcenter position in the closed position of the gate panels.

Preferably the links are arranged substantially at right angles to the mid line when the gate panels are in the closed position.

Preferably the links are moved to a position slightly beyond a right angle to the mid line so as to be overcenter when the gate panels are in the closed position.

Preferably the actuating member defines two pivot points each for a respective one of the links wherein the two pivot points are located symmetrically one each side of the mid line.

Preferably the actuating member comprises a transverse bar at right angles to the mid line with the two pivot points located symmetrically one at each end of the bar.

Preferably there is provided a slide guide for guiding movement of the actuating member along the mid line.

Preferably the actuating member includes a plastic slide block which slides along the slide guide.

Preferably the slide guide comprises a pair of C-channels facing inwardly toward the mid line and each receiving a side portion of the slide block.

Preferably the slide guide provides an end stop for locating the actuating member in an overcenter position when the gate panels are in the closed position.

Preferably the drive member comprises a cylinder and piston mounted on the center line.

Preferably the front gate panels open from the closed position forwardly and the rear gate panels open from the closed position rearwardly.

### BRIEF DESCRIPTION OF THE DRAWINGS

One embodiment of the invention will now be described in conjunction with the accompanying drawings in which:

FIG. 1 is a side elevational view of a hog sorter according to the present invention.

FIG. 2 is a top plan view of the hog sorter of FIG. 1.

FIG. 3 is a top plan view of the actuating mechanism which effects movement of the gate panels, showing the gates in a partly closed condition.

FIG. 4 is a top plan view similar to that of FIG. 3 showing the gate panels in the closed and over center lock position.

FIG. 5 is a front elevational view showing the actuating mechanism of FIGS. 3 and 4.

In the drawings like characters of reference indicate corresponding parts in the different figures.

### DETAILED DESCRIPTION

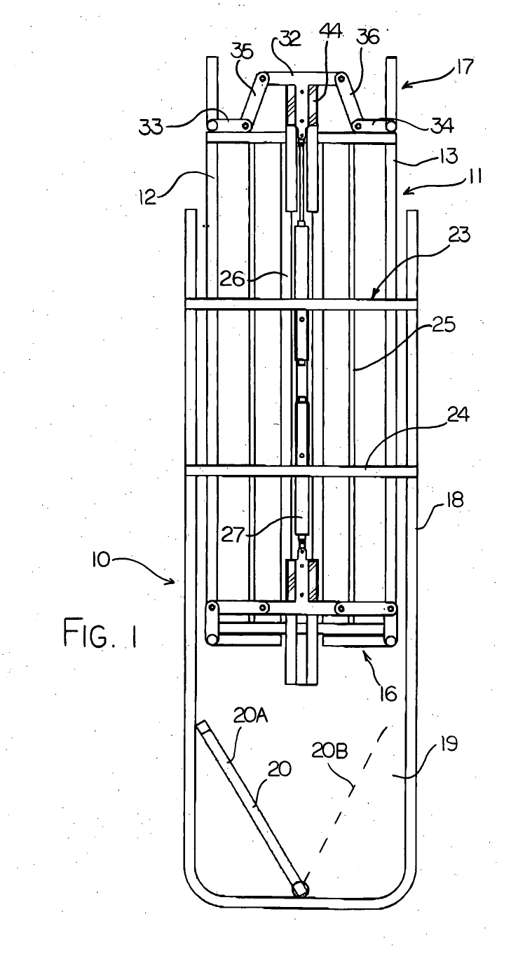

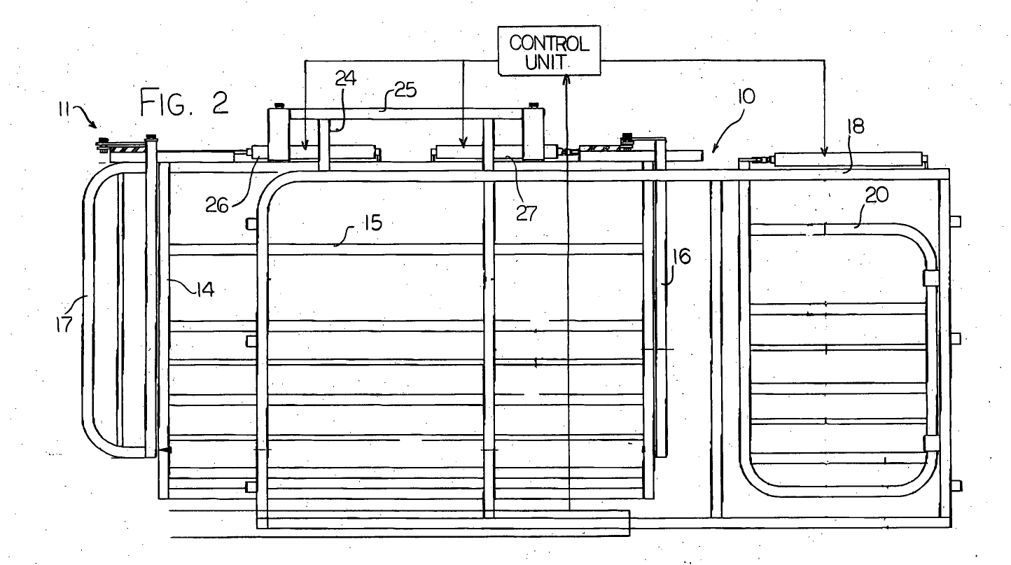

In FIGS. 1 and 2 is shown a hog sorter 10 which includes a confining container or cage 11 for receiving an animal to be sorted. The confining cage is defined by side walls 12 and 13 which are formed by uprights 14 and longitudinal rails 15 so as to form a closed wall along a respective side of the animal to be weighed. The side walls may be formed of sheet material fully enclosing the animal to prevent vision to the sides or may be formed simply from rails as required. In either event the side walls are sufficiently closed to prevent the animal from escaping to the sides. At the front, the container is closed by a front gate 16 and at the rear the container is closed by a rear gate 17. Around the sides and the front of the container is provided a sorting enclosure 18 which defines a front area 19 with a sorting panel 20 which can be moved to one side 20A or to an opposed side 20B depending upon the weight of the animal so that the animal is deflected to one side or the other into a market pen or a holding pen as required. At the bottom of the container 11 is provided a weigh pan 21 on which the animal stands while contained so as to measure the weight of the animal.

A controlled unit 22 is provided for controlling the gates 16 and 17 and the sorting panel 20 to confine the animal, and to allow the escape of the animal when weighed in the required direction.

Across the top of the sorting container 18 is provided a super structure 23 formed by cross rails 24 and longitudinal rails 25 which maintain the integrity of the structure and prevent the animal from escaping or attempting to escape over the side walls or over the gates.

The gates are actuated by cylinders 26 and 27 controlled by the control unit 22 which supplies air to the double acting cylinders to open and close the gates as required.

The control unit can be used to record data concerning particular animals or statistically concerning all the animals passing through so as to provide data to the management concerning average weight gain, expected market date and other relevant data which can be obtained from repeated weighing of the animals as they pass through the sorter.

The above construction is well known and many devices of this type have been sold.

The present invention is primarily concerned with the arrangement for opening and closing the gates utilizing the cylinders 26 and 27 which actuate a linkage arranged to open the gates.

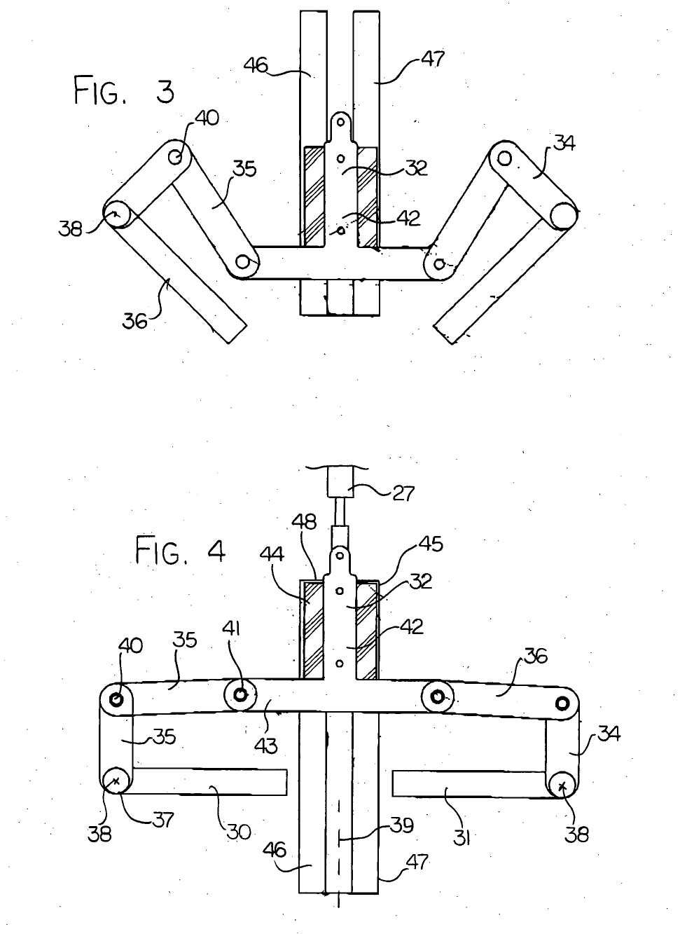

In FIGS. 3, 4 and 5 is shown the actuating mechanism which operates the gates 16 and 17. As the mechanism is symmetrical for the front and rear gates, the mechanism is shown only in one example in FIGS. 3, 4 and 5 but it will be appreciated that front and rear actuating mechanisms are provided as shown in FIG. 2 with the arrangements being symmetrical.

Each of the gates is formed by a pair of gate panels 30 and 31. The gate panels of the front gate open forwardly and the gate panels of the rear gate open rearwardly. In operation, therefore, front gates are generally closed and the animal is encouraged to pass into the sorter on its way to for example a feeding station so that the animal knows that the path to the feeding station passes through the sorter and thus requires the animal to pass through the sorter before reaching the feed. With the front gates closed and the rear gates opened, a single animal enters the sorter and its presence is detected by the weigh pan. When the animal has entered, the rear gates are closed thus confining the animal between the front and rear gates. Using the mechanism described hereinafter, the gates are prevented from being pushed open by the animal moving forwardly or rearwardly within the container.

When the animal has been weighed, the sorting panel is moved to the required location and the front gates are opened allowing the animal to exit from the container to the required location.

The linkage for actuating movement of the gate panels 30 and 31 comprises an actuator member 32, a left lever 33, a right lever 34, a left link 35 and a right link 36. Each of the gate panels 30 and 31 is mounted for pivotal movement on a pivot mounting 37 for pivotal movement about a vertical axis 38 at the outside or side walls of the container. Thus in the closed position, the gate panels extend at right angles to a mid line 39 of the container toward the mid line from the outer edge at the axes 38. The gate panels thus lie in a common plane at right angles to the mid line 39 leaving a narrow space between the gate panel which is insufficient to allow the animal to escape.

In the open position the gate panels are pivoted through 90° to a position lying in a common plane with the side walls of the container and parallel to the mid line 39.

Movement through 90° about the axes 38 is effected by the left lever 33 and the right lever 34. Thus a pulling action inwardly on the levers 33 and 34 acts to pivot the gate panels around the axis 38 to the required open position.

Each of the links 35 and 36 includes a pivot mounting 40 at its outer end at the end of the respective lever 33, 34. Each of the links 35, 36 has at its inner end a pivot mounting 41 attached to an outer end of the actuator 32.

The actuator 32 is in the form of a T-bar with a longitudinal member 42 lying on and extending along the center line 49. A transverse bar portion 33 of the actuator extends outwardly at right angles to the mid line 39 to the outer ends at which are located the pivot mountings 41 for the links 35 and 36. The actuator is symmetrical so that the mountings 41 are located symmetrically one on each side of the mid line 39.

The actuator 32 is mounted on a plastic block 44 slidable on a guide track 45 extending along the mid line 39. The guide track is formed from a pair of flanges 46 and 47 arranged each on a respective side of the mid line 39 and facing inwardly so as to extend into receiving slots in the rectangular block 44 which slides along the track 44 longitudinally along the mid line 39. At one end of the track 45 is provided an end stop 48 which stops the movement of the block 44 in the closed position of the gate panels.

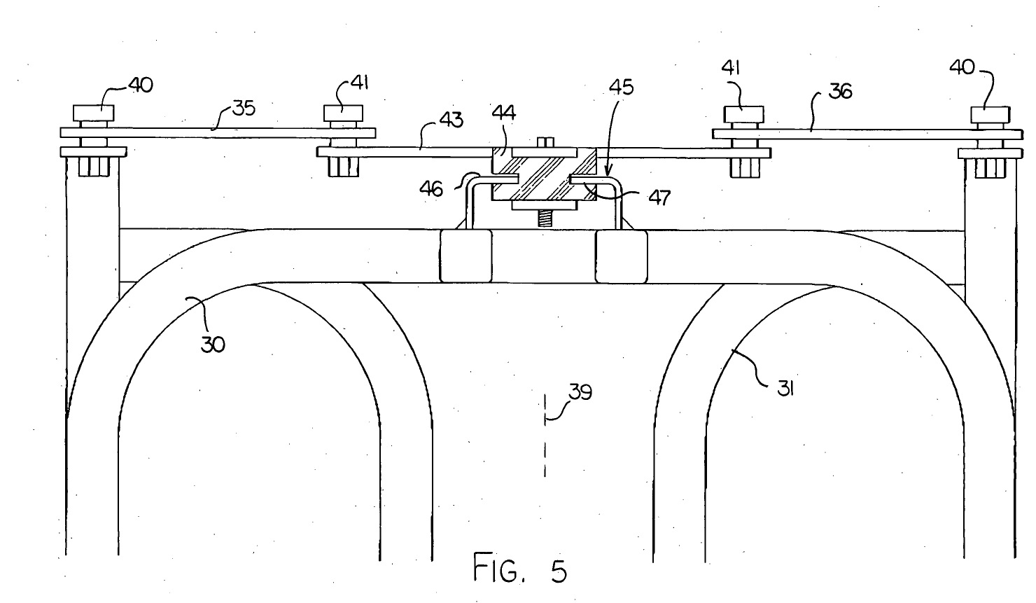

Thus as shown in FIG. 4, the block 44 is located at the end stop 48 in the closed position of the gate panels and in this position the links 35 and 36 extend substantially at right angles to the mid line 39 from the levers 33, 34 inwardly to the respective end of the actuator 43 and particularly the ends of the T-bar 43. Furthermore, as shown in FIG. 4, the links are moved to a position slightly over center so that the pivot points 41 are slightly rearward of the pivot mountings 40. Forward pressure on the gate panels 30 and 31 therefore tends to push the actuator 42 rearwardly toward the end stop 48 so that no pressure is applied to the cylinder or drive member 27. As the links 35 and 36 extend generally at right angles to the mid line, any force longitudinal of the links provided by pivotal movement of the levers 33 and 34 is very small since the mechanical advantage is very small so that even if the cylinder were not taken over center but were merely directly in line, there would be substantially no force on the cylinder.

Opening movement of the gate panels is effected by actuating the cylinder 27 to move the block 44 in the forward direction along the track 45 through the position shown in FIG. 3 which is partly opened to the position shown in FIG. 2 at the rear end where the gate panels of the rear gate are fully opened. It will be appreciated that the movement of the actuator pulls the links so that their inner end moves longitudinally thus pulling their outer end inwardly and pulling on the respective lever 33, 34.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A livestock sorter comprising:
side walls defining a confining container for an animal to be sorted;
a base plate on which the animal stands when confined in the container;
a weighing scale supporting the base plate for obtaining a weight of the animal when confined as it stands on the base plate;
a front gate at the front of the container moveable from an open position allowing passage of the animal to a closed position for preventing forward movement of the animal while it is being weighed;
a rear gate at the rear of the container moveable from an open position allowing passage of the animal to a closed position for preventing rearward movement of the animal while it is being weighed;
the front gate comprising a left side vertical gate panel and a right side vertical gate panel;
each of the gate panels being pivotal about a vertical axis at an outer edge of the gate panel from the closed position extending across the container generally at right angles to a mid line toward the mid line though an angle of the order of 90 degrees to an open position generally parallel to the mid line;
and front and a rear drive construction for effecting movement of the front and rear gates respectively between the open and closed positions, each drive construction comprising:
a left lever connected to the left gate panel and arranged such that pivotal movement of the left lever about the axis of the left gate panel causes said pivotal movement of the left gate panel;
a right lever connected to the right gate panel and arranged such that pivotal movement of the right lever about the axis of the right gate panel causes said pivotal movement of the right gate panel;
an actuating member movable along the midline of the container in response to an actuating force from a drive member;
a left link pivotally connected to the actuating member and to the left lever;
a right link pivotally connected to the actuating member and to the right lever;
the actuating member, the links and the levers being arranged such that movement of the actuating member to a first position along the mid line causes the actuating member to provide a force on the levers through the links to pivot the gate panels to the open position and such that movement of the actuating member to a second position along the mid line causes the actuating member to provide a force on the levers through the links to pivot the gate panels to the closed position;
the actuating member, the links and the levers being arranged such that, in the second position with the gate panels in the closed position, force from the animal on the gate panels tending to open the gate panels provides substantially no force through the links and the actuating member to the drive member.

2. The livestock sorter according to claim 1 wherein the links and the actuation member are arranged in an overcenter position in the closed position of the gate panels.

3. The livestock sorter according to claim 1 wherein the links are arranged substantially at right angles to the mid line when the gate panels are in the closed position.

4. The livestock sorter according to claim 3 wherein the links are moved to a position slightly beyond a right angle to the mid line so as to be overcenter when the gate panels are in the closed position.

5. The livestock sorter according to claim 1 wherein the actuating member defines two pivot points each for a respective one of the links wherein the two pivot points are located symmetrically one each side of the mid line.

6. The livestock sorter according to claim 5 wherein the actuating member comprises a transverse bar at right angles to the mid line with the two pivot points located symmetrically one at each end of the bar.

7. The livestock sorter according to claim 1 wherein there is provided a slide guide for guiding movement of the actuating member along the mid line.

8. The livestock sorter according to claim 7 wherein the actuating member includes a plastic slide block which slides along the slide guide.

9. The livestock sorter according to claim 8 wherein the slide guide comprises a pair of C-channels facing inwardly toward the mid line and each receiving a side portion of the slide block.

10. The livestock sorter according to claim 7 wherein the slide guide provides an end stop for locating the actuating member in an overcenter position when the gate panels are in the closed position.

11. The livestock sorter according to claim 1 wherein the drive member comprises a cylinder and piston mounted on the center line.

12. The livestock sorter according to claim 1 wherein the front gate panels open from the closed position forwardly and the rear gate panels open from the closed position rearwardly.
